(19) United States
(12) Patent Application Publication
(10) Pub. No.: US 2024/0329617 A1
(43) Pub. Date: Oct. 3, 2024

(54) MACHINING STATE DETECTION APPARATUS, MACHINING STATE DETECTION METHOD, PROGRAM, DICING APPARATUS, AND LEARNING MODEL GENERATION METHOD

(71) Applicant: Tokyo Seimitsu Co., Ltd., Tokyo (JP)

(72) Inventors: Hiroya SHINOHARA, Tokyo (JP); Tasuku SHIMIZU, Tokyo (JP)

(73) Assignee: Tokyo Seimitsu Co., Ltd., Tokyo (JP)

(21) Appl. No.: 18/622,329

(22) Filed: Mar. 29, 2024

(30) Foreign Application Priority Data
Mar. 31, 2023 (JP) 2023-059106

(51) Int. Cl. G05B 19/406; G05B 13/02

(52) U.S. Cl. CPC G05B 19/406; G05B 13/0265

(57) ABSTRACT

A machining state detection apparatus acquires an environmental temperature history, a blade supply water temperature history, and a heat source supply water temperature history, and derives an environmental temperature history feature amount, a blade supply water temperature history feature amount, and a heat source supply water temperature history feature amount, and when a machining error is predicted based on a temperature history feature amount including the environmental temperature history feature amount, the blade supply water temperature history feature amount and the heat source supply water temperature history feature amount, with a learning model which is trained using the temperature history feature amount and the machining error as learning data and which outputs a prediction value of the machining error, when the temperature history feature amount is input.

### CROSS-REFERENCE TO RELATED APPLICATION

The present application claims priority under 35 U.S.C § 119 (a) to Japanese Patent Application No. 2023-059106 filed on Mar. 31, 2023, which is hereby expressly incorporated by reference, in its entirety, into the present application.

### BACKGROUND OF THE INVENTION

### Field of the Invention

The present disclosure relates to a machining state detection apparatus, a machining state detection method, a program, a dicing apparatus, and a learning model generation method.

### Description of the Related Art

A dicing apparatus that machines a workpiece is required to implement high-accuracy machining under a wide variety of environments. To implement highly-accurate machining in a dicing step, it is extremely important to manage an environment under which the apparatus is installed, such as a room temperature (temperature of a room) and a water temperature. For example, under an environment in which the room temperature largely changes, it is concerned that machining accuracy may be deteriorated due to thermal expansion and thermal contraction of respective units provided in the apparatus.

Typically, machining accuracy of the dicing apparatus is not guaranteed in all temperature range, but an operating temperature range is specified. The dicing apparatus is guaranteed to achieve specified machining accuracy when it is operated in the specified operating temperature range.

Japanese Patent Application Laid-Open No. 2015-076516 discloses a dicing apparatus that monitors an ambient temperature around a machining position using a temperature sensor and corrects at least one of a feed amount of a spindle movement mechanism or a feed amount of a work table based on the monitored temperature of a shaft. The apparatus disclosed in Japanese Patent Application Laid-Open No. 2015-076516 includes various kinds of data maps such as displacement characteristics of a spindle with respect to time, infers position displacement of a machining point in association with the data maps, and performs a cutting and dividing work while correcting feeding of a workpiece.

### PRIOR ART DOCUMENT

Patent Literature 1: Japanese Patent Application Laid-Open No. 2015-076516

### SUMMARY OF THE INVENTION

However, some users may have difficulty in using the apparatus while satisfying the specified operating temperature range, due to a facility environment, or the like. In a case where the apparatus is used in an environment deviated from the operating temperature range, cutter setting, calf check, and the like, are corrected at appropriate timings, and whether the specified machining accuracy is satisfied is determined in a state where correction has been made. Here, a user may set the correction timings and make final determination on the machining accuracy.

Further, in a case where the room temperature largely changes within one year, it may be necessary to take measures such as change of operation of the apparatus in accordance with seasons in which the apparatus is operated. Still further, although disturbance elements such as the room temperature and various kinds of water temperatures may be corrected as independent parameters, temperature factors are related to each other in most cases, and thus, it is difficult to implement correction with high accuracy.

The apparatus disclosed in Japanese Patent Application Laid-Open No. 2015-076516 includes correction maps respectively for parameters and can correct for each of the parameters, but it is difficult to cope with a case where temperature factors are related to each other.

The present disclosure has been made in view of such circumstances and aims to provide a machining state detection apparatus, a machining state detection method, a program, a dicing apparatus, and a learning model generation method which may detect a machining state with respect to changes in temperature factors related to each other.

According to a first aspect of the present disclosure, a machining state detection apparatus that detects a machining state when a workpiece is machined with a blade, includes: an environmental temperature history acquiring unit that acquires an environmental temperature history representing a temperature history of a machining environment; a blade supply water temperature history acquiring unit that acquires a blade supply water temperature history representing a temperature history of blade supply water supplied to the blade; a heat source supply water temperature history acquiring unit that acquires a heat source supply water temperature history representing a temperature history of heat source supply water supplied to a heat source that produces heat when the workpiece is machined; a temperature history feature amount deriving unit that derives an environmental temperature history feature amount representing features of the environmental temperature history, a blade supply water temperature history feature amount representing features of the blade supply water temperature history, and a heat source supply water temperature history feature amount representing features of the heat source supply water temperature history; and a machining error predicting unit that predicts a machining error based on a temperature history feature amount including the environmental temperature history feature amount, the blade supply water temperature history feature amount and the heat source supply water temperature history feature amount, wherein the machining error predicting unit employs a learning model which is trained using the temperature history feature amount and the machining error as learning data, and outputs the machining error in a case where the temperature history feature amount is input.

The machining state detection apparatus according to the present disclosure detects a machining state with respect to a change of the environmental temperature, a change of the blade supply water temperature, and a change of the heat source supply water temperature, which are related to each other. Thus, it is possible to implement correction in accordance with a temperature history.

The blade supply water may include cutting water, blade cooling water and cleaning water. The heat source supply water can include heat source cooling water. The heat source may include a spindle, a camera and supporting members that support the spindle and the camera.

According to a second aspect, the machining state detection apparatus according to the first aspect may further include: a machining state history acquiring unit that acquires a machining state history representing a history of a machining state; and a machining state history feature amount deriving unit that derives a feature amount of the machining state history, in which the machining error predicting unit may predict the machining error while the feature amount of the machining state history is taken into account in the temperature history feature amount.

In the second aspect, the machining state in which fluctuation of the actual machining state is taken into account is detected, so that it is possible to implement correction in accordance with the fluctuation of the actual machining state.

According to a third aspect, in the machining state detection apparatus according to the first aspect, the temperature history feature amount deriving unit may acquire a temperature of the machining environment and a change amount of the temperature of the machining environment per unit time as the environmental temperature history feature amount, acquire a temperature of the blade supply water and a change amount of the temperature of the blade supply water per unit time as the blade supply water temperature history feature amount, and acquire a temperature of the heat source supply water and a change amount of the temperature of the heat source supply water per unit time as the heat source supply water temperature history feature amount, and the learning model may be generated by performing training using: a combination of the temperature of the machining environment and the change amount of the temperature of the machining environment per unit time; a combination of the temperature of the blade supply water and the change amount of the temperature of the blade supply water per unit time; and a combination of the temperature of the heat source supply water and the change amount of the temperature of the heat source supply water per unit time, as input, to output the machining error.

In the third aspect, it is possible to detect a machining state in which change amounts of various kinds of temperatures per unit time are taken into account for various kinds of temperatures.

According to a fourth aspect, in the machining state detection apparatus according to the first aspect, the temperature history feature amount deriving unit may acquire a temperature of the machining environment, a change amount of the temperature of the machining environment per unit time, and a direction of a change of the temperature of the machining environment as the environmental temperature history feature amount, acquire a temperature of the blade supply water, a change amount of the temperature of the blade supply water per unit time, and a direction of a change of the temperature of the blade supply water as the blade supply water temperature history feature amount, and acquire a temperature of the heat source supply water, a change amount of the temperature of the heat source supply water per unit time, and a direction of a change of the temperature of the heat source supply water as the heat source supply water temperature history feature amount, and the learning model may be generated by performing training using: a combination of the temperature of the machining environment, the change amount of the temperature of the machining environment per unit time, and the direction of the change of the temperature of the machining environment; a combination of the temperature of the blade supply water, the change amount of the temperature of the blade supply water per unit time, and the direction of the change of the temperature of the blade supply water; and a combination of the temperature of the heat source supply water, the change amount of the temperature of the heat source supply water per unit time, and the direction of the change of the temperature of the heat source supply water, as input, to output the machining error.

In the fourth aspect, it is possible to detect the machining state in which the change amounts of various kinds of temperatures per unit time, and the directions of the changes of various kinds of temperatures are taken into account for various kinds of temperatures.

According to a fifth aspect, in the machining state detection apparatus according to the first aspect, the temperature history feature amount deriving unit may acquire a temperature of the machining environment and an integrated value of the temperature of the machining environment as the environmental temperature history feature amount, acquire a temperature of the blade supply water and an integrated value of the temperature of the blade supply water as the blade supply water temperature history feature amount, and acquire a temperature of the heat source supply water and an integrated value of the temperature of the heat source supply water as the heat source supply water temperature history feature amount, and the learning model may be generated by performing training using: a combination of the temperature of the machining environment and the integrated value of the temperature of the machining environment; a combination of the temperature of the blade supply water and the integrated value of the temperature of the blade supply water; and a combination of the temperature of the heat source supply water and the integrated value of the temperature of the heat source supply water, as input, to output the machining error.

In the fifth aspect, it is possible to detect the machining state in which the integrated values of various kinds of temperatures are taken into account for various kinds of temperatures.

According to a sixth aspect, the machining state detection apparatus according to any one of the first aspect to the fifth aspect, may further include: a machining condition acquiring unit that acquires machining conditions to be applied to the machining; and a learning model selecting unit that selects a learning model to be employed in the machining error predicting unit in accordance with the machining conditions, from a plurality of first learning models generated by performing training for the respective machining conditions.

In the sixth aspect, it is possible to detect the machining state in which the learning model is applied in accordance with the machining conditions.

According to a seventh aspect of the present disclosure, a machining state detection method of detecting a machining state when a workpiece is machined with a blade, includes: an environmental temperature history acquiring step of acquiring, by a control device, an environmental temperature history representing a temperature history of a machining environment; a blade supply water temperature history acquiring step of acquiring, by the control device, a blade supply water temperature history representing a temperature history of blade supply water supplied to the blade; a heat source supply water temperature history acquiring step of acquiring, by the control device, a heat source supply water temperature history representing a temperature history of heat source supply water supplied to a heat source that produces heat when the workpiece is machined; a temperature history feature amount deriving step of deriving, by the control device, an environmental temperature history feature amount representing features of the environmental temperature history, a blade supply water temperature history feature amount representing features of the blade supply water temperature history, and a heat source supply water temperature history feature amount representing features of the heat source supply water temperature history; and a machining error predicting step of predicting, by the control device, a machining error based on a temperature history feature amount including the environmental temperature history feature amount, the blade supply water temperature history feature amount and the heat source supply water temperature history feature amount, wherein the machining error predicting step employs a learning model which is trained using the temperature history feature amount and the machining error as learning data, and outputs the machining error in a case where the temperature history feature amount is input.

The machining state detection method according to the present disclosure, enables to provide operational effects similar to those of the machining state detection apparatus according to the present disclosure.

In the machining state detection method according to the present disclosure, matters similar to the matters specified in any one of the second aspect to the sixth aspect may be combined as appropriate. In this case, components which perform processing and functions specified in the machining state detection apparatus may be grasped as components of the machining state detection method, which perform processing and functions corresponding to these.

According to an eighth aspect of the present disclosure, a program for causing a control device to detect a machining state when a workpiece is machined using a blade, causes the control device to implement functions including: an environmental temperature history acquiring function of acquiring an environmental temperature history representing a temperature history of a machining environment; a blade supply water temperature history acquiring function of acquiring a blade supply water temperature history representing a temperature history of blade supply water supplied to the blade; a heat source supply water temperature history acquiring function of acquiring a heat source supply water temperature history representing a temperature history of heat source supply water supplied to a heat source that produces heat when the workpiece is machined; a temperature history feature amount deriving function of deriving an environmental temperature history feature amount representing features of the environmental temperature history, a blade supply water temperature history feature amount representing features of the blade supply water temperature history, and a heat source supply water temperature history feature amount representing features of the heat source supply water temperature history; and a machining error predicting function of predicting a machining error based on a temperature history feature amount including the environmental temperature history feature amount, the blade supply water temperature history feature amount and the heat source supply water temperature history feature amount, wherein the machining error predicting function employs a learning model which is trained using the temperature history feature amount and the machining error as learning data, and outputs the machining error in a case where the temperature history feature amount is input.

The program according to the present disclosure may implement operational effects similar to those of the machining state detection apparatus according to the present disclosure.

In the program according to the present disclosure, matters similar to the matters specified in any one of the second aspect to the sixth aspect may be combined as appropriate. In this case, components which perform processing and functions specified in the machining state detection apparatus may be grasped as components of the program, which perform processing and functions corresponding to these.

According to a ninth aspect of the present disclosure, a dicing apparatus includes: a machining unit that machines a workpiece with a blade; and a machining state detecting unit that detects a machining state of the workpiece. The machining state detecting unit includes: an environmental temperature history acquiring unit that acquires an environmental temperature history representing a temperature history of a machining environment; a blade supply water temperature history acquiring unit that acquires a blade supply water temperature history representing a temperature history of blade supply water supplied to the blade; a heat source supply water temperature history acquiring unit that acquires a heat source supply water temperature history representing a temperature history of heat source supply water supplied to a heat source that produces heat when the workpiece is machined; a temperature history feature amount deriving unit that derives an environmental temperature history feature amount representing features of the environmental temperature history, a blade supply water temperature history feature amount representing features of the blade supply water temperature history, and a heat source supply water temperature history feature amount representing features of the heat source supply water temperature history; and a machining error predicting unit that predicts a machining error based on a temperature history feature amount including the environmental temperature history feature amount, the blade supply water temperature history feature amount, and the heat source supply water temperature history feature amount, wherein the machining error predicting unit employs a learning model which is trained using the temperature history feature amount and the machining error as learning data, and outputs the machining error in a case where the temperature history feature amount is input.

The dicing apparatus according to the present disclosure, may implement operational effects similar to those of the machining state detection apparatus according to the present disclosure.

In the dicing apparatus according to the present disclosure, matters similar to the matters specified in any one of the second aspect to the sixth aspect may be combined as appropriate. In this case, components which perform processing and functions specified in the machining state detection apparatus may be grasped as components of the dicing apparatus, which perform processing and functions corresponding to these.

According to a tenth aspect, the dicing apparatus according to the ninth aspect may further include a determining unit that determines whether or not it is necessary to correct the machining unit based on the machining error output from the machining error predicting unit.

In the tenth aspect, it is possible to determine whether or not it is necessary to correct the machining unit based on the machining error.

According to an eleventh aspect, in the dicing apparatus according to the tenth aspect, the machining error predicting unit may predict a machining error after a specified period has elapsed, and the determining unit may derive a determination result indicating that it is necessary to correct the machining unit in a case where the predicted machining error exceeds a specified threshold.

In the eleventh aspect, it is possible to determine whether or not it is necessary to correct the machining unit based on prediction of a future machining error.

According to a twelfth aspect, in the dicing apparatus according to the eleventh aspect, the machining error predicting unit may predict a machining error after a specified period has elapsed based on a change amount of the machining error per unit time and a direction of a change of the machining error.

In the twelfth aspect, it is possible to determine whether or not it is necessary to correct the machining unit based on prediction of the machining error in which the direction of the change of the machining error is taken into account.

According to a thirteenth aspect of the present disclosure, a learning model generation method of generating a learning model which outputs a machining error when a workpiece is machined with a blade in a case where the temperature history feature amount is input, includes a step of training, using learning data including a temperature history feature amount including an environmental temperature history representing a temperature history of a machining environment, a blade supply water temperature history representing a temperature history of blade supply water supplied to the blade, and a heat source supply water temperature history representing a temperature history of heat source supply water supplied to a heat source that produces heat when the workpiece is machined, and a machining error when the workpiece is machined.

The learning model generation method according to the present disclosure, enables to generate the trained learning model applicable to the machining state detection apparatus, the machining state detection method, the program, and the dicing apparatus according to the present disclosure.

According to the present disclosure, it is possible to detect a machining state with respect to a change of an environmental temperature, a change of a blade supply water temperature and a change of a heat source supply water temperature which are related to each other. Thus, correction may be performed in accordance with a temperature history.

### BRIEF DESCRIPTION OF THE DRAWINGS

FIG. 1 is a perspective view illustrating a schematic configuration of a dicing apparatus according to an embodiment;

FIG. 2 is a perspective view illustrating a schematic configuration of a machining unit illustrated in FIG. 1;

FIG. 3 is a perspective view illustrating a configuration example of a spindle tip part;

FIG. 4 is a functional block diagram illustrating an electrical configuration of the dicing apparatus illustrated in FIG. 1;

FIG. 5 is a functional block diagram illustrating an electrical configuration of a machining state detecting unit illustrated in FIG. 1;

FIG. 6 is a flowchart indicating flow of a machining state detection method according to the embodiment;

FIG. 7 is a flowchart indicating procedure of processing to be applied to an analyzing unit illustrated in FIG. 5;

FIG. 8 is a schematic diagram of a learning model to be applied to a machining error predicting unit illustrated in FIG. 5;

FIG. 9 is an explanatory diagram of a temperature history;

FIG. 10 is an explanatory diagram of a change amount of a temperature per unit time;

FIG. 11 is a schematic diagram of a learning model generation method;

FIG. 12 is an explanatory diagram of a first modification of a temperature history feature amount;

FIG. 13 is an explanatory diagram of a second modification of the temperature history feature amount;

FIG. 14 is an explanatory diagram of a third modification of the temperature history feature amount; and

FIG. 15 is a schematic diagram of a learning model generation method in which the temperature history feature amount according to the third modification is used as learning data.

### DETAILED DESCRIPTION OF THE PREFERRED EMBODIMENTS

A preferred embodiment of the present disclosure will be described below in accordance with the accompanying drawings. In the present specification, the same reference numerals will be assigned to the same components, and redundant description will be omitted as appropriate.

### [Configuration Example of Dicing Apparatus According to Embodiment]

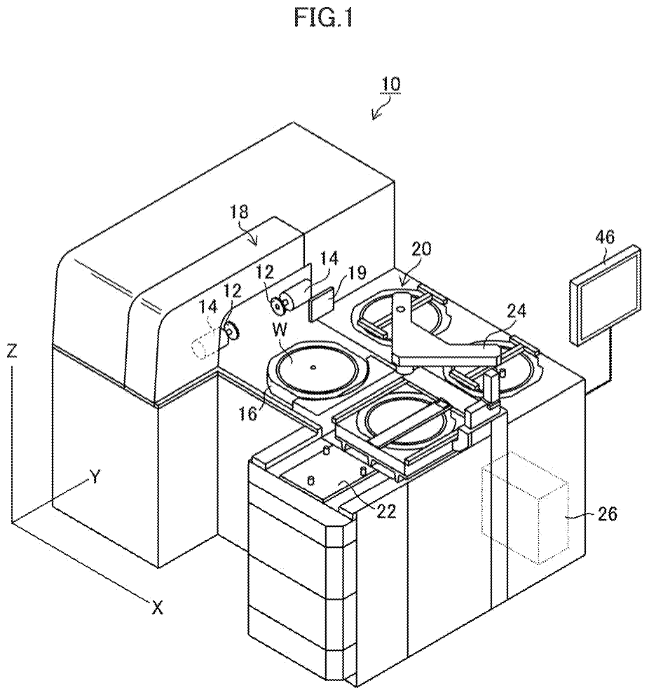

FIG. 1 is a perspective view illustrating a schematic configuration of a dicing apparatus according to the embodiment. Note that an X direction and a Y direction illustrated in FIG. 1 represent directions which are perpendicular to each other, and parallel to a surface on which the dicing apparatus is placed. Further, a Z direction represents a direction which is perpendicular to the X direction and the Y direction, and parallel to a direction perpendicular to the surface on which the dicing apparatus is placed.

The dicing apparatus 10 illustrated in FIG. 1 is a dicing apparatus called a twin spindle dicer in which a pair of blades 12, 12 is disposed so as to face each other. The dicing apparatus 10 includes: a machining unit 18 including a pair of blades 12, 12; a pair of spindles 14, 14 which have blades 12 at their tip parts and in which a high-frequency motor is incorporated; and a work table 16 on which a workpiece W, that is an object to be machined, is placed. The workpiece W is sucked and retained on the work table 16. The machining unit 18 moves the workpiece W and the blade 12 relatively to each other on a surface parallel to an XY plane, to perform cutting processing on the workpiece W using the blade 12. Note that cutting processing may be referred to as “dicing processing” or the like. Examples of a material of the workpiece W may include a semiconductor material such as silicon and silicon carbide. Other examples of the material of the workpiece W may include materials such as sapphire, glass and quartz, other than the semiconductor material.

The dicing apparatus 10 includes a camera 19 that captures an image of a surface of the workpiece W, a cleaning unit 20 that performs spin cleaning of the machined workpiece W (cleaning of the workpiece W while rotating the work table 16), a load port 22 on which cassettes storing workpieces W are placed, and a conveying apparatus 24 that conveys the workpiece W. The camera 19, and the like, are respectively disposed at specified positions. The dicing apparatus 10 further includes a control device 26 that performs integrated control on operation of respective units of the dicing apparatus 10. The control device 26 may be disposed inside the dicing apparatus 10.

The control device 26 is an example of an apparatus control means in the present disclosure, and a computer may be applied as the control device 26. The computer that functions as the control device 26 may include one or more processors and one or more computer-readable media. The computer implements various kinds of functions in the dicing apparatus 10 when the one or more processors execute a program including one or more commands recorded on the computer-readable media. Note that details of an electrical configuration of the control device 26 will be described later.

The dicing apparatus 10 includes a display unit 46. The display unit 46 is electrically connected to the control device 26 and displays various kinds of information such as a result of dicing processing, a state of a partial breakage of the blade 12 and various kinds of data. As the display unit 46, a display apparatus with a touch panel may be applied. An operator of the dicing apparatus 10 may input various kinds of information such as settings of machining conditions for the control device 26 and a threshold for determining a state of the blade 12 using the touch panel.

### [Configuration Example of Machining Unit]

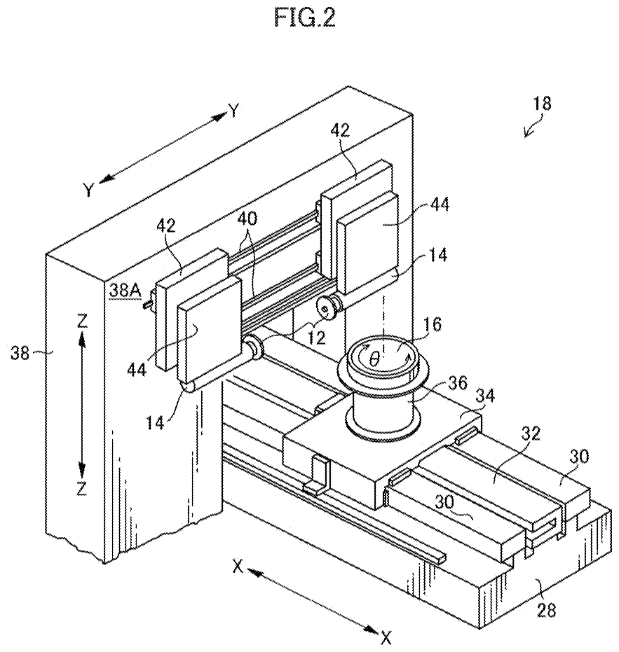

FIG. 2 is a perspective view illustrating a schematic configuration of the machining unit illustrated in FIG. 1. The machining unit 18 illustrated in FIG. 2 includes an X table 34. The X table 34 is guided with a pair of X guides 30, 30 provided on an X base 28 and driven in an X direction with a linear motor 32. Further, a rotation table 36 that rotates around a θ direction is provided so as to be erected on an upper surface of the X table 34. A work table 16 is provided on the rotation table 36. The work table 16 moves in the X direction using the X table 34 and rotates in the θ direction using the rotation table 36. Note that the θ direction represents a direction of rotation around a rotation axis extending in a direction parallel to the Z direction.

The machining unit 18 includes a Y base 38 which is formed to have a gate shape disposed at a position across the X base 28. A pair of Y tables 42, 42 are provided on a front surface 38A of the Y base 38. A pair of Y tables 42, 42 are guided using a pair of Y guides 40, 40 fixed on the front surface 38A of the Y base 38 and driven in a Y direction using a Y drive apparatus. The Y drive apparatus includes a motor and a feed screw device.

A pair of Z tables 44, 44 are respectively provided on the pair of Y tables 42, 42. The Z table 44 is guided using a Z guide provided on the Y table 42 and driven in a Z direction using a Z drive apparatus. The Z drive apparatus may have a configuration similar to that of the Y drive apparatus. Note that illustration of the Y drive apparatus, the Z guide and the Z drive apparatus is omitted.

A pair of spindles 14, 14 are respectively fixed on the pair of Z tables 44, 44 so as to face each other. A pair of blades 12, 12 mounted on respective tip parts of the pair of spindles 14, 14 are disposed so as to face each other along the Y direction.

Each of the pair of blades 12, 12 is indexed in the Y direction, and fed while notching (while grooving) in the Z direction (notching feed). Further, the work table 16 is fed while the workpiece W is cut in the X direction (cutting feed), and rotates in the e direction. These operations are controlled using the control device 26 illustrated in FIG. 1.

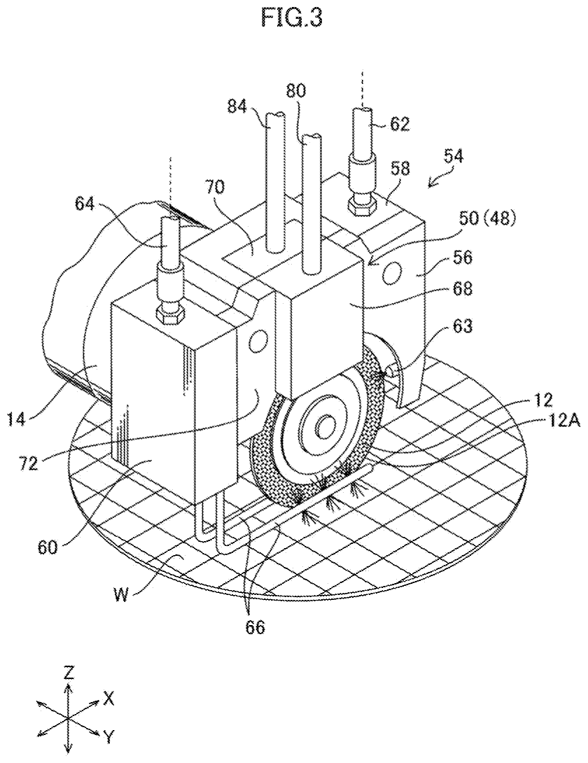

FIG. 3 is a perspective view illustrating a configuration example of a spindle tip part. A wheel cover 54 that covers the blade 12 is attached to the tip part of the spindle 14 illustrated in FIG. 3. The wheel cover 54 includes a cover front part 56, a cover rear part 58, a nozzle block 60, and a guide block 72. A hose 62 is connected to the cover rear part 58. Cutting water supplied via the hose 62 is sprayed toward the rotating blade 12 from the nozzle 63 provided to the wheel cover 54. A hose 64 is connected to the nozzle block 60. Blade cooling water supplied via the hose 64 is sprayed toward a machining point of the workpiece W to be machined with the blade 12, from a pair of nozzles 66, 66 provided to the wheel cover 54.

While not illustrated, in the dicing apparatus 10, heat source cooling water is used to cool heat sources inside the apparatus, such as the spindle 14, a microscope including the camera 19, a Z-axis structure and a scale supporting part. In other words, the dicing apparatus 10 includes a second cooling water supply unit that supplies the heat source cooling water to the heat sources other than the blade 12. Further, the dicing apparatus 10 includes a cleaning water supply unit that supplies cleaning water.

A flow path of blade supply water including the cutting water, the blade cooling water and the cleaning water branches into flow paths to respective supply destinations, and then the blade supply water is discharged inside the apparatus. That is, the flow paths are an open system. On the other hand, the heat source cooling water is industrial water, such as urban water, and fed to cool the heat sources such as a spindle motor and the microscope (camera 19), and parts such as the Z-axis structure and the scale supporting part, which are required to have the same temperature as the heat sources. The flow paths of the heat source cooling water are closed systems.

The dicing apparatus 10 is provided with a blade breakage detection apparatus 48 that detects a partial breakage which occurs in a blade edge 12A of the blade 12. The control device 26 provided to the dicing apparatus 10 grasps a state of the blade 12 based on a detection result of the blade breakage detection apparatus 48.

The blade breakage detection apparatus 48 includes a photodetection unit 50. The photodetection unit 50 is attached to the wheel cover 54 at a central position in the X direction of the wheel cover 54 and disposed at a position on the opposite side in the Z direction with respect to a machining position of the blade 12. The photodetection unit 50 includes a light projecting unit 68 and a light receiving unit 70. A light projection side wiring 80 is connected to the light projecting unit 68, and a light reception side wiring 84 is connected to the light receiving unit 70.

The light projecting unit 68 and the light receiving unit 70 provided in the photodetection unit 50 are disposed at positions so as to face each other across the blade 12 in the Y direction. The light projecting unit 68 includes a light projecting element such as an LED. The light projecting unit 68 may include an LED array including a plurality of LEDs. Power is supplied to the light projecting element from a power supply apparatus via the light projection side wiring 80. Note that illustration of the power supply apparatus is omitted.

The light receiving unit 70 receives at least part of light radiated toward the blade 12 from the light projecting unit 68. The light receiving unit 70 includes a light receiving element such as a photodiode. The light receiving unit 70 may include a photodiode array including photodiodes. The light receiving element outputs a detection signal having a current value in accordance with a received light amount. The detection signal output from the light receiving element is transmitted to the control device 26 via the light reception side wiring 84.

### [Electrical Configuration of Dicing Apparatus]

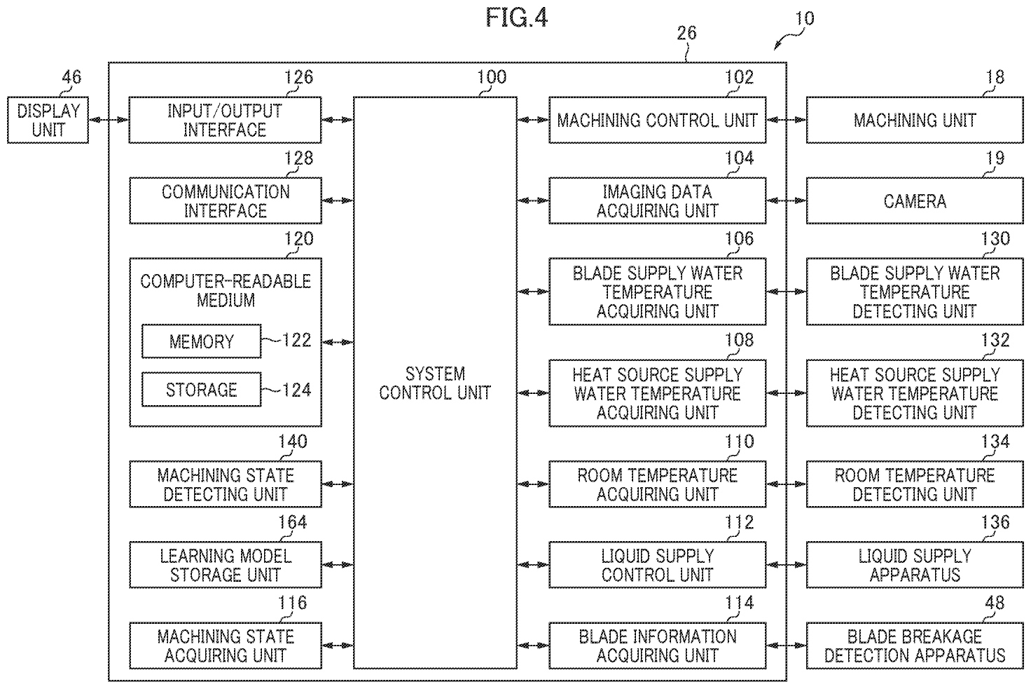

FIG. 4 is a functional block diagram illustrating an electrical configuration of the dicing apparatus illustrated in FIG. 1. The control device 26 includes a system control unit 100. The system control unit 100 controls various kinds of control units provided in the dicing apparatus 10 in an integrated manner. The system control unit 100 controls writing of data, and the like, to a computer-readable medium 120 and reading of data, and the like, from the computer-readable medium 120.

The control device 26 includes a machining control unit 102. The machining control unit 102 controls operation of respective units of the machining unit 18 based on a command signal transmitted from the system control unit 100. The machining control unit 102 functions as a drive control unit that controls operation of an X drive apparatus, a Y drive apparatus, a Z drive apparatus and a θ drive apparatus provided in the machining unit 18. Further, the machining control unit 102 functions as a spindle control unit that controls operation of the spindle 14.

The control device 26 includes an imaging data acquiring unit 104. The imaging data acquiring unit 104 acquires imaging data of the generated workpiece W captured using the camera 19. The imaging data of the workpiece W acquired by the imaging data acquiring unit 104 is used to grasp a machining error of the workpiece W when alignment, calf check, and the like are performed.

The control device 26 includes a blade supply water temperature acquiring unit 106, a heat source supply water temperature acquiring unit 108, and a room temperature acquiring unit 110. The blade supply water temperature acquiring unit 106 acquires temperatures of cutting water, blade cooling water and cleaning water detected by a blade supply water temperature detecting unit 130. The blade supply water temperature acquiring unit 106 acquires time-series data of the temperatures of the cutting water, and the like, at a specified sampling period.

The heat source supply water temperature acquiring unit 108 acquires a temperature of the heat source cooling water detected by a heat source supply water temperature detecting unit 132. The heat source supply water temperature acquiring unit 108 acquires time-series data of the temperature of the heat source cooling water at a specified sampling period.

The room temperature acquiring unit 110 detects a room temperature detected by a room temperature detecting unit 134. The room temperature is grasped as an environmental temperature in an environment in which the dicing apparatus 10 is installed. The room temperature acquiring unit 110 acquires time-series data of the room temperature at a specified sampling period. The sampling periods applied to the blade supply water temperature acquiring unit 106, the heat source supply water temperature acquiring unit 108, and the room temperature acquiring unit 110 may be the same or different from each other. The blade supply water temperature detecting unit 130, the heat source supply water temperature detecting unit 132 and the room temperature detecting unit 134 include temperature sensors. The temperature sensors may be contact type sensors or non-contact type sensors.

The control device 26 includes a liquid supply control unit 112. The liquid supply control unit 112 controls operation of a liquid supply apparatus 136 based on a command signal transmitted from the system control unit 100. In other words, the liquid supply control unit 112 controls supply timings and supply amounts of the blade supply water and the heat source supply water.

The liquid supply apparatus 136 may include a blade supply water supply unit that supplies the blade supply water, and a heat source supply water supply unit that supplies the heat source supply water. The blade supply water supply unit may include a cutting water supply unit that supplies the cutting water, a blade cooling water supply unit that supplies the blade cooling water, and a cleaning water supply unit that supplies the cleaning water.

The liquid supply control unit 112 may include a blade supply water supply control unit and a heat source supply water supply control unit. The blade supply water supply control unit may include a cutting water supply control unit, a blade cooling water supply control unit, and a cleaning water supply control unit.

The control device 26 includes a blade information acquiring unit 114. The blade information acquiring unit 114 acquires a detection result of the blade 12 output from the blade breakage detection apparatus 48. The control device 26 determines whether or not there is a partial breakage of the blade 12 based on the detection result of the blade 12.

The control device 26 includes a machining state acquiring unit 116. The machining state acquiring unit 116 acquires a parameter representing an actual machining state such as rotation speed of the spindle 14. The machining state acquiring unit 116 may acquire the parameter representing the actual machining state based on machining conditions set by the machining control unit 102. The machining state acquiring unit 116 may acquire a period having passed from the change of the machining state. For example, a period from when supply of the heat source cooling water is started, or a period from when machining of each channel is started may be acquired. Further, in a case where the rotation speed of the spindle 14 is changed, or cutter setting (measurement of a wear amount) and calf check are performed during machining, a period having passed from the change of the rotation speed of the spindle 14, or a period having passed from the cutter setting during machining, and the like, may be acquired.

The control device 26 includes a machining state detecting unit 140. The machining state detecting unit 140 predicts a machining error of the workpiece W based on various kinds of temperature information acquired during machining of the workpiece W and the actual machining state. The machining state detecting unit 140 may predict a machining error after a specified period has elapsed based on a change amount of the machining error per unit time and a direction of the change amount. The machining state detecting unit 140 predicts a hazardous state indicating that the machining error of the workpiece W is likely to be greater.

The machining state detecting unit 140 may function as a determining unit that determines whether or not it is necessary to correct the machining unit 18 in a case where the hazardous state indicating that the machining error of the workpiece W is likely to be greater is predicted. The machining state detecting unit 140 may derive a determination result indicating that it is necessary to correct the machining unit 18, in a case where the predicted machining error exceeds a specified threshold.

The control device 26 includes a learning model storage unit 164. The learning model storage unit 164 stores a learning model which is to be used to predict the machining error. The learning model is applied to the machining state detecting unit 140. Note that details of prediction of the machining error will be described later.

One or more processors are applied as hardware of various kinds of processing units such as the system control unit 100 illustrated in FIG. 4. One processing unit or two or more processing units may be implemented with one processor, or one processing unit may be implemented with a plurality of processors.

A central processing unit (CPU) that is a general-purpose processing device may be provided as the processor (processors), or a processing device dedicated to specific processing may be provided as the processor (processors). The processors may be the same type of processors, or the processors may be different types different from each other.

The control device 26 includes the computer-readable medium 120. The computer-readable medium 120 is a non-transitory tangible object (entity), and is provided with a memory 122 that is a main storage device and a storage 124 that is an auxiliary storage device. As the computer-readable medium 120, a semiconductor memory, a hard disk device, a solid state drive device, or the like may be used. As the computer-readable medium 120, any combination of these devices may be used.

Note that the hard disk device may be referred to as an HDD that is an abbreviation of a hard disk drive in English notation. The solid state drive device may be referred to as an SSD that is an abbreviation of a solid state drive in English notation.

The control device 26 includes an input/output interface 126 and a communication interface 128. The display unit 46 is connected to the control device 26 via the input/output interface 126. The input/output interface 126 may employ various kinds of standards such as a universal serial bus (USB).

The control device 26 performs data communication with an external apparatus via the communication interface 128. As a communication form of the communication interface 128, any of wired communication or wireless communication may be applied. The control device 26 may be connected to a network via the communication interface 128 so as to be able to perform communication with an external apparatus. As the network, a local area network (LAN), or the like, may be applied. Note that illustration of the network is omitted.

FIG. 4 illustrates components such as a processing unit, related to processing of the dicing apparatus 10 illustrated in FIG. 1, and the like. The dicing apparatus 10 may include components such as a processing unit, not illustrated in FIG. 4.

### [Configuration Example of Processing State Detecting Unit]

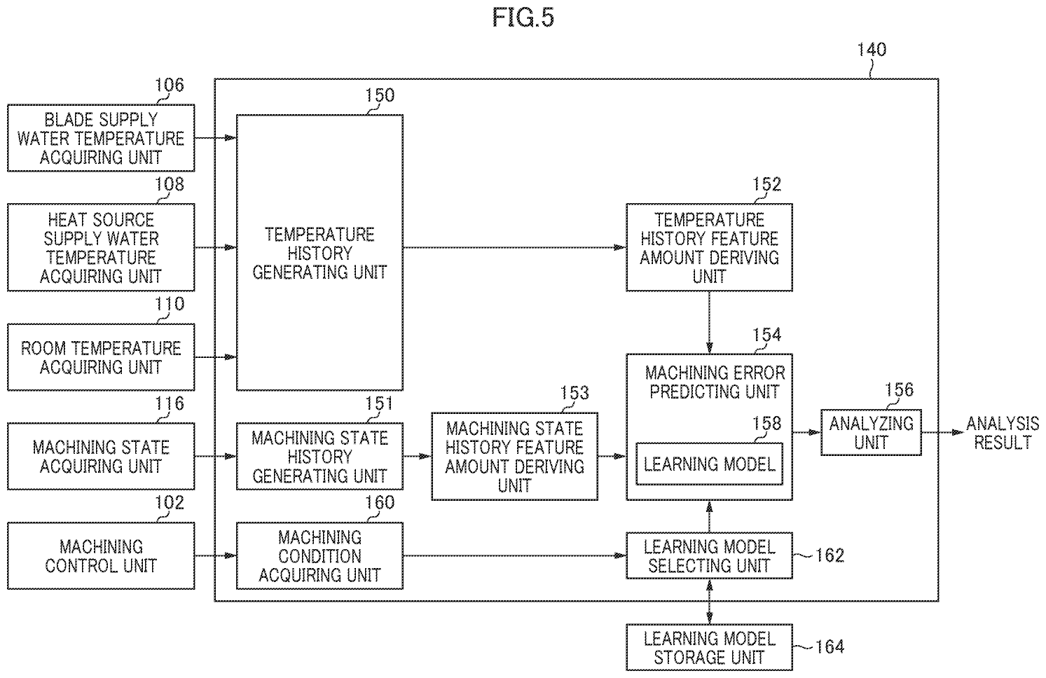

FIG. 5 is a functional block diagram illustrating an electrical configuration of the machining state detecting unit illustrated in FIG. 4. The machining state detecting unit 140 includes a temperature history generating unit 150, a machining state history generating unit 151, a temperature history feature amount deriving unit 152, a machining state history feature amount deriving unit 153, a machining error predicting unit 154, and an analyzing unit 156. The machining error predicting unit 154 includes a trained learning model (trained machine-learning model) 158.

The temperature history generating unit 150 generates a temperature history of the blade supply water from the temperature of the blade supply water such as the cutting water, transmitted from the blade supply water temperature acquiring unit 106. As the temperature history of the blade supply water, time-series data of the temperature of the blade supply water is applied.

Further, the temperature history generating unit 150 generates a temperature history of the heat source cooling water from the temperature of the heat source cooling water, transmitted from the heat source supply water temperature acquiring unit 108. As the temperature history of the heat source cooling water, time-series data of the temperature of the heat source cooling water is applied. Further, the temperature history generating unit 150 generates a history of the room temperature from the room temperature, transmitted from the room temperature acquiring unit 110. As the history of the room temperature, time-series data of the room temperature is applied.

Note that the temperature history generating unit 150 described in the embodiment is an example of the blade supply water temperature history acquiring unit that acquires a blade supply water temperature history representing the temperature history of the blade supply water, and is an example of hardware with which a program implements the blade supply water temperature history acquiring function.

Further, the temperature history generating unit 150 described in the embodiment is an example of the heat source supply water temperature history acquiring unit that acquires the temperature history of the heat source supply water supplied to the heat sources that generate heat when the workpiece is machined, and is an example of hardware with which a program implements the heat source supply water temperature history acquiring function.

Further, the temperature history generating unit 150 described in the embodiment is an example of the environmental temperature history acquiring unit that acquires an environmental temperature history representing a temperature history of a machining environment, and is an example of hardware with which a program implements the environmental temperature history acquiring function.

The machining state history generating unit 151 generates a machining state history from an actual machining state acquired using the machining state acquiring unit 116. Examples of the machining state history include time-series data of the rotation speed of the spindle 14. Note that the machining state history generating unit 151 described in the embodiment is an example of the machining state history acquiring unit that acquires the machining state history representing the history of the machining state.

The temperature history feature amount deriving unit 152 derives a temperature history feature amount including a feature amount of the temperature history of the blade supply water, a feature amount of the temperature history of the heat source supply water, and a feature amount of the history of the room temperature. For example, as the feature amount of the temperature history of the blade supply water, a pair of the temperature of the blade supply water and a gradient (slope, inclination) of the temperature of the blade supply water may be applied.

In other words, the feature amount of the temperature history of the blade supply water includes a pair of the temperature of the cutting water and a gradient of the temperature of the cutting water, a pair of the temperature of the blade cooling water and a gradient of the temperature of the blade cooling water, and a pair of the temperature of the cleaning water and a gradient of the temperature of the cleaning water. Further, the feature amount of the temperature history of the heat source supply water includes a pair of the temperature of the heat source cooling water and a gradient of the temperature of the heat source cooling water.

The gradient of the temperature of the blade supply water is derived as a temperature change per unit time at sampling timings at which the temperatures of the blade supply water are acquired. For example, the gradient of the temperature change of the blade supply water may be derived by applying a sampling period of the temperature of the blade supply water as unit time and using the temperatures of the blade supply water acquired at successive sampling timings.

As the feature amount of the temperature history of the heat source supply water, a pair of the temperature of the heat source supply water and a gradient of a temperature change of the heat source supply water may be applied. The gradient of the temperature change of the heat source supply water is derived as the temperature change per unit time at sampling timings at which the temperatures of the heat source supply water are acquired. Further, as the feature amount of the history of the room temperature, a pair of the room temperature and a gradient of a change of the room temperature may be applied. The gradient of the change of the room temperature may be derived as the temperature change per unit time at sampling timings at which the room temperatures are acquired.

Note that the temperature history feature amount deriving unit 152 described in the embodiment is an example of hardware in which a program implements the temperature history feature amount deriving function.

The machining state history feature amount deriving unit 153 derives a feature amount of the machining state history. Examples of the feature amount of the machining state history can include a pair of the rotation speed of the spindle 14 and a gradient of the rotation speed of the spindle 14. For example, in a case where the rotation speed of the spindle 14 is set at 40 krpm (km rotation per minute) as machining conditions of a channel 1, the rotation speed of the spindle 14 is set at 50 krpm as machining conditions of a channel 2, and machining is sequentially performed in order of the channel 1 and the channel 2, the rotation speed of the spindle 14 changes during machining. There is a case where position variation may occur due to change of the rotation speed of the spindle 14. In other words, the machining state has a time constant, and the time constant may be used to predict the machining error.

The machining error predicting unit 154 predicts the machining error when the workpiece W is machined based on the feature amount of the temperature history and the feature amount of the machining state history, using the trained learning model 158. The temperature history described here is a collective term of the temperature history of the blade supply water, the temperature history of the heat source supply water and the history of the room temperature.

The learning model 158 is a trained machine-learning model which is trained using a pair of the feature amount of the temperature history and the machining error as learning data, to output a prediction value of the machining error when the feature amount of the temperature history is input. In other words, in generation of the learning model 158, supervised learning is performed using a pair of the feature amount of the temperature history and the machining error as the learning data. In other words, the learning model 158 is trained to output the prediction value of the machining error when the temperature history feature amount is input.

When the feature amount of the temperature history derived from the temperature acquired at an arbitrary sampling timing is input to the learning model 158, the learning model 158 outputs a prediction value of the machining error at the sampling timing at which the temperature is acquired.

As the learning model 158, a neural network such as a deep neural network may be applied. A value derived through training using software is applied as a weight and bias of the neural network. Note that the deep neural network may be referred to as a DNN which is abbreviation of a deep neural network in English notation.

The learning model 158 may be constituted as a trained learning model which is additionally trained using a pair of the feature amount of the machining state history and the machining error, as learning data. The learning model 158 outputs the prediction value of the machining error, when the feature amount of the temperature history and the feature amount of the machining state history are input.

Note that the machining error predicting unit 154 described in the embodiment is an example of hardware with which a program implements the machining error predicting function.

The analyzing unit 156 predicts transition of a future machining error during machining based on the prediction result of the machining error output from the learning model 158 provided to the machining error predicting unit 154. In a case where occurrence of the machining error exceeding a specified allowable range is predicted, the analyzing unit 156 outputs a signal indicating that the occurrence of the machining error exceeding the specified allowable range is predicted as an analysis result. In a case where the occurrence of the machining error exceeding the specified allowable range is predicted, the control device 26 can implement machining correction at an appropriate timing.

The machining state detecting unit 140 includes a machining condition acquiring unit 160. The machining condition acquiring unit 160 acquires machining conditions such as a type of the workpiece W and a type of the blade 12 applied to the machining unit 18, from the machining control unit 102.

The machining state detecting unit 140 includes a learning model selecting unit 162. The learning model selecting unit 162 selects a learning model corresponding to the machining conditions acquired by the machining condition acquiring unit 160, from learning models generated by performing training for each of the machining conditions and stored in the learning model storage unit 164. The learning model selected by the learning model selecting unit 162 is applied to the machining error predicting unit 154. The learning model storage unit 164 may be provided in an external apparatus of the control device 26. Note that the learning models generated by performing training for each of the machining conditions described in the embodiment is an example of a plurality of first learning models.

### [Procedure of Machining State Detection Method]

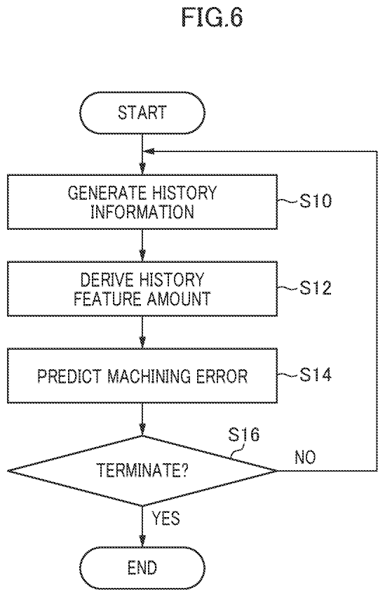

FIG. 6 is a flowchart indicating flow of a machining state detection method according to the embodiment. The machining state detection method whose the procedures are shown in FIG. 6 may be implemented when the control device 26 having a computer executes a specified program.

In a history information generating step S10, the temperature history generating unit 150 illustrated in FIG. 5 generates the temperature history of the blade supply water, the temperature history of the heat source supply water, the history of the room temperature, and the like. In the history information generating step S10, the machining state history generating unit 151 generates the machining state history. After the history information generating step S10, a history feature amount deriving step S12 is executed. Note that the history information generating step S10 described in the embodiment is an example of an environmental temperature history acquiring step, a blade supply water temperature history acquiring step and a heat source supply water temperature history acquiring step.

In the history feature amount deriving step S12, the temperature history feature amount deriving unit 152 generates the temperature history feature amount of the blade supply water, the temperature history feature amount of the heat source supply water, the history feature amount of the room temperature, and the like. In the history feature amount deriving step S12, the machining state history feature amount deriving unit 153 generates the feature amount of the machining state history. After the history feature amount deriving step S12, a machining error predicting step S14 is executed. Note that the history feature amount deriving step S12 described in the embodiment is an example of a temperature history feature amount deriving step.

In the machining error predicting step S14, the machining error predicting unit 154 applies the learning model 158 and predicts the machining error corresponding to the temperature history feature amount of the cutting water, the temperature history feature amount of the cooling water, and the history feature amount of the room temperature. The machining error predicting step S14 is grasped as an inferring step of the learning model 158. The prediction result of the machining error is output to the analyzing unit 156 illustrated in FIG. 5. After the machining error predicting step S14, the processing proceeds to a termination determining step S16.

In the termination determining step S16, the machining state detecting unit 140 determines whether or not to terminate detection of the machining state. In the termination determining step S16, in a case where specified termination conditions are not satisfied, and it is determined to continue detection of the machining state, a determination result of No is obtained. In a case where the determination result of No is obtained, the processing proceeds to the history information generating step S10, and respective steps from the history information generating step S10 to the termination determining step S16 are repeatedly executed until a determination result of Yes is obtained in the termination determining step S16.

On the other hand, in a case where the specified termination conditions are satisfied, and it is determined to terminate detection of the machining state in the termination determining step S16, a determination result of Yes is obtained. In a case where the determination result of Yes is obtained, specified termination processing is performed, and detection of the machining state is terminated.

Here, before the machining error predicting step S14, a machining condition acquiring step of acquiring machining conditions and a learning model selecting step of selecting a learning model in accordance with the machining conditions may be executed, and then the machining error predicting step S14 may be executed using the selected learning model.

### [Procedure of Processing of Analyzing Unit]

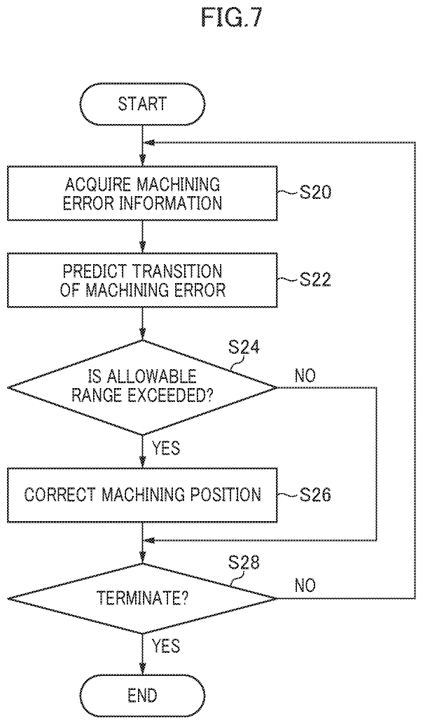

FIG. 7 is a flowchart indicating procedure of processing to be applied to the analyzing unit 156 illustrated in FIG. 5. In a machining error acquiring step S20 indicated in FIG. 7, the analyzing unit 156 illustrated in FIG. 5 acquires the machining error output from the machining error predicting unit 154. Specifically, in the machining error acquiring step S20, a prediction result of the machining error predicted in the machining error predicting step S14 indicated in FIG. 6 is acquired. After the machining error acquiring step S20, the processing proceeds to a machining error transition predicting step S22.

In the machining error transition predicting step S22, the analyzing unit 156 predicts transition of a future machining error. In other words, in the machining error transition predicting step S22, a hazardous state indicating that the machining error is likely to increase is predicted. The hazardous state indicating that the machining error is likely to increase means a state in which if the temperature change continues as is, an error occurs.

Specifically, in the machining error transition predicting step S22, it is predicted whether or not the machining error increases. In a case where it is predicted that the machining error increases, it is predicted whether or not the machining error exceeds an allowable range. After the machining error transition predicting step S22, the processing proceeds to a machining error determining step S24.

In the machining error determining step S24, in a case where it is predicted that the machining error transitions within the allowable range, a determination result of No is obtained, and the processing proceeds to a termination determining step S28. On the other hand, in a case where it is predicted in the machining error determining step S24 that the machining error exceeds the allowable range, a determination result of Yes is obtained, and the processing proceeds to a machining position correcting step S26.

In the machining error determining step S24, an alarm may be output in a case where the determination result of Yes is obtained. Examples of the alarm may include a mode where character information is displayed at the display unit 46 illustrated in FIG. 1 and a mode where sound is used.

In the machining position correcting step S26, separately from the recipe conditions, calf check is performed a current machining position is checked, and the machining position is corrected based on the current machining position. In other words, in the machining position correcting step S26, the machining position is corrected by applying a function, which is provided to the dicing apparatus 10, of checking the machining position and correcting the machining position in a case where an error of the machining position exceeds an allowable range, at a more appropriate timing than the recipe conditions. After the machining position correcting step S26, the processing proceeds to the termination determining step S28.

In the termination determining step S28, it is determined whether or not to terminate analysis processing. Examples of termination of the analysis processing include termination of machining of the workpiece W, termination due to occurrence of an error, and the like. In the termination determining step S28, in a case where it is determined to continue the analysis processing, a determination result of No is obtained. In a case where the determination result of No is obtained, the processing proceeds to the machining error acquiring step S20, and respective steps from the machining error acquiring step S20 to the termination determining step S28 are repeatedly executed until a determination result of Yes is obtained in the termination determining step S28.

On the other hand, in a case where it is determined to terminate the analysis processing in the termination determining step S28, a determination result of Yes is obtained. In a case where the determination result of Yes is obtained, specified termination processing is performed, and the procedure of the analysis processing is terminated.

### [Specific Example of Learning Model]

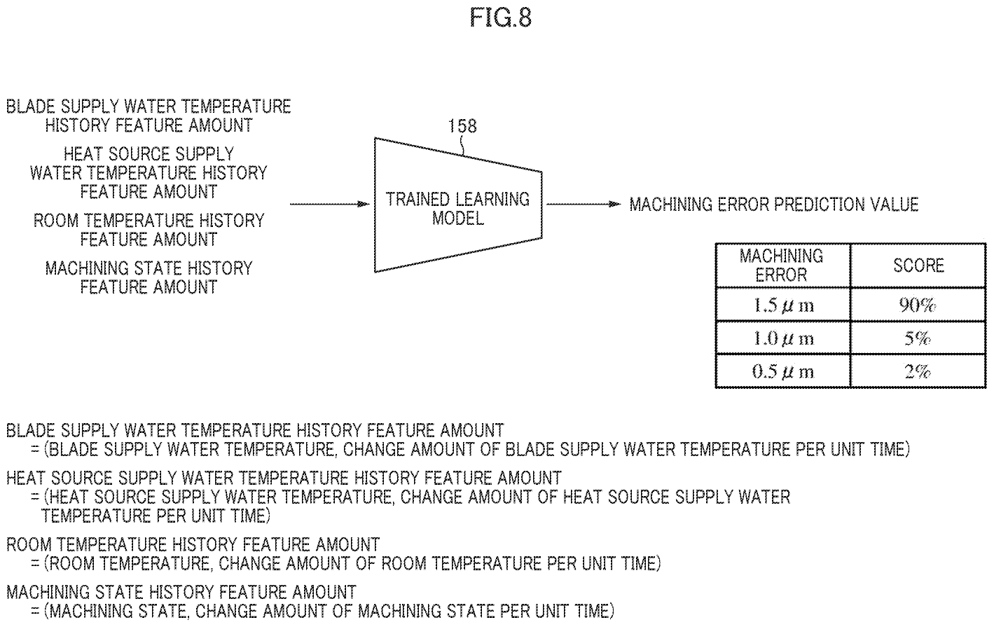

FIG. 8 is a schematic diagram of the learning model to be applied to the machining error predicting unit illustrated in FIG. 5. The learning model 158 outputs a prediction value of the machining error at timings when the blade supply water temperature, the heat source supply water temperature and the room temperature are acquired, when the blade supply water temperature history feature amount, the hearing element supply water temperature history feature amount, and the room temperature history feature amount are input. As the prediction value of the machining error, a mode where a score representing a correct answer probability is given may be applied. The learning model 158 may output the prediction value of the machining error in which the actual machining state is taken into account.

As the blade supply water temperature history feature amount, a pair of the blade supply water temperature at a timing at which the blade supply water temperature is acquired and a change amount of the blade supply water temperature per unit time at the timing at which the blade supply water temperature is acquired, may be applied.

As the heat source supply water temperature history feature amount, a pair of the heat source supply water temperature at a timing at which the heat source supply water temperature is acquired, which is the same timing as the timing at which the blade supply water temperature is acquired, and a change amount of the heat source supply water temperature per unit time at the timing at which the heat source supply water temperature is acquired, may be applied.

As the room temperature history feature amount, a pair of the room temperature at a timing at which the room temperature is acquired, which is the same timing as the timing at which the blade supply water temperature is acquired, and a change amount of the room temperature per unit time at the timing at which the room temperature is acquired may be applied. As the machining state history feature amount, a pair of the machining state at a timing at which the machining state is acquired and a change amount of the machining state per unit time at the timing at which the machining state is acquired, may be applied. The same timing described here may include displacement in an allowable range. For example, a timing displaced by an amount less than a sampling period of each temperature may be grasped as substantially the same timing.

The prediction values of the machining error illustrated in FIG. 8 indicate that a probability of the machining error being 1.5 micro meters or less is 90%, a probability of the machining error being 1.0 micro meters or less is 5%, and a probability of the machining error being 0.5 micro meters or less is 2%. Note that the room temperature history feature amount described in the embodiment is an example of the environmental temperature history feature amount representing features of the environmental temperature history.

### [Periods Until Temperatures of Respective Units are Saturated With Respect to Various Kinds of Temperature Changes]

Periods until temperatures of respective units are saturated with respect to a change of the room temperature are as follows:
Workpiece: 3 (three) minutes
Table: 5 (five) minutes
Spindle: 10 (ten) minutes
Microscope: 10 (ten) minutes
Z-axis structure: 1 (one) hour
Casting: 8 (eight) hours

Periods until the temperatures of the respective units are saturated with respect to the temperature change of the blade supply water or switching from OFF to ON of the blade supply water are as follows:
Workpiece: 1 (one) minute or less
Table: 3 (three) minutes
Spindle: 10 (ten) minutes
Microscope: 5 (five) minutes
Z-axis structure: 20 (twenty) minutes
Casting: 1 (one) hour

Periods until the temperatures of the respective units are saturated with respect to the temperature change of the heat source supply water or switching from OFF to ON of the heat source supply water are as follows:
Spindle: 2 (two) minutes
Z-axis structure: 10 (ten) minutes
Scale: 2 (two) minutes
Microscope: 1 (one) minute

The above-described temperature values are rough indications of periods until the temperature changes of the respective units substantially converge in a case where each temperature is changed by 2° C. under reference temperature conditions.

For example, the microscope is affected by the change of the room temperature, the temperature change of the blade supply water, and the temperature change of the heat source supply water. In a case where the room temperature rises, the microscope alone is shifted toward a negative side in the Y axis direction with respect to the workpiece W due to expansion of a member that supports the microscope. However, shift toward a positive side in the Y axis direction also occurs due to expansion of the workpiece W, and further, in a case where the temperature changes of the Z-axis structure and the casting catch up with the change of the room temperature, extension with respect to the workpiece W is slightly reduced.

As to the blade supply water rising, the microscope alone is shifted toward the negative side in the Y axis direction with respect to the workpiece W due to expansion of the member that supports the microscope only in a cutting state. However, in a case where the temperature of the blade supply water is shifted from a state where the temperature is higher than the room temperature reference temperature by 2° C. to a state where the temperature is higher than the room temperature reference temperature by 4°° C., and where the temperature after rising is lower than the room temperature reference temperature plus 2° C., the microscope alone is shifted toward the positive side in the Y axis direction. Further, the temperature change of the blade supply water causes the positional shift in the Y axis direction due to expansion of the workpiece W and the positional shift in the Y axis direction due to expansion of the spindle 14. Thus, even in a case where the temperature rises by 2° C., behavior becomes different depending on the temperature difference between the blade supply water and the room temperature.

The temperature rise of the heat source supply water shifts the microscope toward the negative side in the Y axis direction with respect to the workpiece W due to expansion of the member that supports the microscope and expansion of a member that supports the camera. Because the heat source supply water used for the spindle 14 is the same as that used for the microscope, the spindle 14 also expands and the position of the spindle 14 is shifted in the Y axis direction. On the other hand, in a case where the scale is water cooled, shifting of the spindle 14 is cancelled.

Time constants with respect to various kinds of temperature changes are different, and the time constants vary under conditions other than the reference temperature conditions. This occurs due to a change of a temperature gradient of each unit and inversion of a direction of the gradient. It is therefore difficult to estimate the machining error due to position displacement between the workpiece W and the microscope and position displacement between the workpiece W and the blade 12 based on temperature measurement at a time point.

In the present embodiment, fluctuation of various kinds of temperatures are monitored for a fixed period from a time point specified in advance after machining is started, and the machining error is predicted using the appropriate learning model 158. By this means, correction is performed at an appropriate timing so that it is possible to reduce the machining error. Further, in a case where the learning model 158 in which the history of the machining state is taken into account is used, the machining error due to fluctuation of the machining state may be reduced.

### [Specific Example of Temperature History]

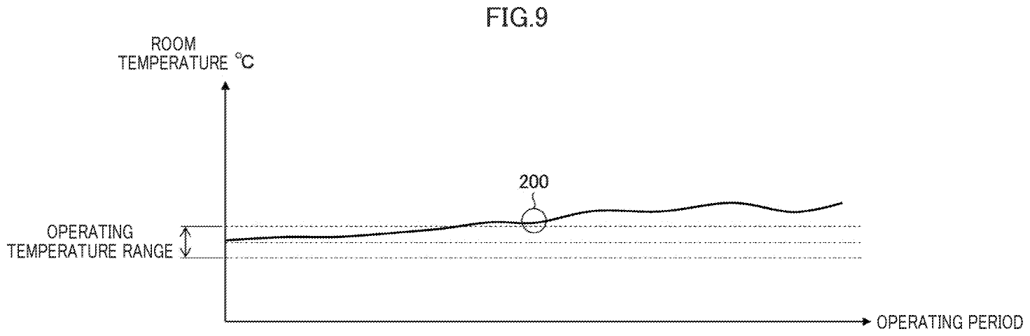

FIG. 9 is an explanatory diagram of the temperature history. FIG. 9 indicates a temperature history with a graph in which the horizontal axis indicates time and the vertical axis indicates a temperature. The temperature history may be understood as time-series data of temperatures which are successively acquired at a specified sampling period. As shown in FIG. 9, the temperatures in the temperature history may include a temperature outside an operating temperature range as well as a temperature within the operating temperature range of the apparatus.

For example, the reference temperature of the room temperature and the reference temperature of the heat source supply water may be 22° C. Further, for example, the reference temperature of the blade supply water may be 24° C. The reference temperature of the heat source supply water may be the same as the reference temperature of the room temperature. The reference temperature of the blade supply water may be specified at plus 2° C. with respect to the reference temperature of the room temperature (that is, the reference temperature of the blade supply water may be specified at a temperature higher than the reference temperature of the room temperature by 2° C.).

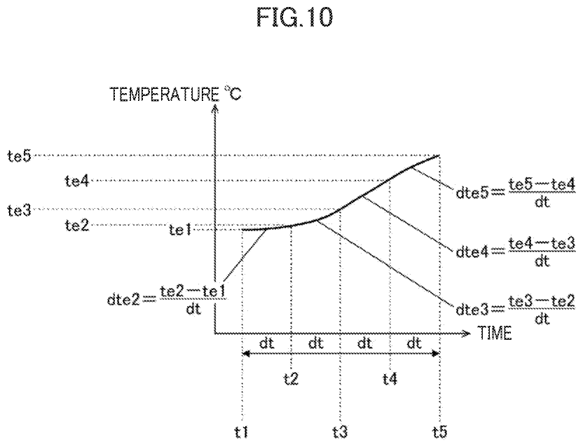

FIG. 10 is an explanatory diagram of the change amount of the temperature per unit time. FIG. 10 shows a region 200 in the temperature history shown in FIG. 9 in an enlarged manner. Note that an expediential time axis and an expediential temperature axis are shown in FIG. 10.

### [Specific Example of Temperature History Feature Amount]

A timing t1, a timing t2, a timing t3, a timing t4 and a timing t5 shown in FIG. 10 are respectively timings at which a temperature Te1, a temperature Te2, a temperature Te3, a temperature Te4 and a temperature Te5 are acquired. A time interval dt between the respective timings is a sampling period of the temperature.

A change amount of the temperature per unit time at each timing is calculated as an average change rate of a function representing the temperature history. For example, a change amount of the temperature per unit time at the timing t2 is (Te2−Te1)/dt. In a similar manner, a change amount of the temperature per unit time at the timing t3 is (Te3−Te2)/dt. In other words, assuming that i indicates an integer of 1 or greater, a change amount of the temperature per unit time at the i-th timing ti is represented as {Tei−Te (i−1)}/dt.

In other words, assuming that the temperature history is represented as f(t) using a function, the change amount of the temperature per unit time at the i-th timing ti is represented as a first derivative df(ti)/dt of the temperature history f(t).

When the temperature history feature amount deriving unit 152 illustrated in FIG. 5 acquires the temperature history shown in FIG. 9 from the temperature history generating unit 150, the temperature history feature amount deriving unit 152 derives the temperature for each temperature acquisition timing and the change amount of the temperature per unit time for each temperature acquisition timing as the temperature history feature amount.

The machining state history feature amount may be represented using the rotation speed, and the like, of the spindle 14 in a similar manner to the temperature history feature amount, in place of the temperature of the temperature history feature amount. In other words, the machining state history feature amount deriving unit 153 may acquire the machining history from the machining state history generating unit 151 and derive the machining state history feature amount.

### [Learning Model Generation Method]

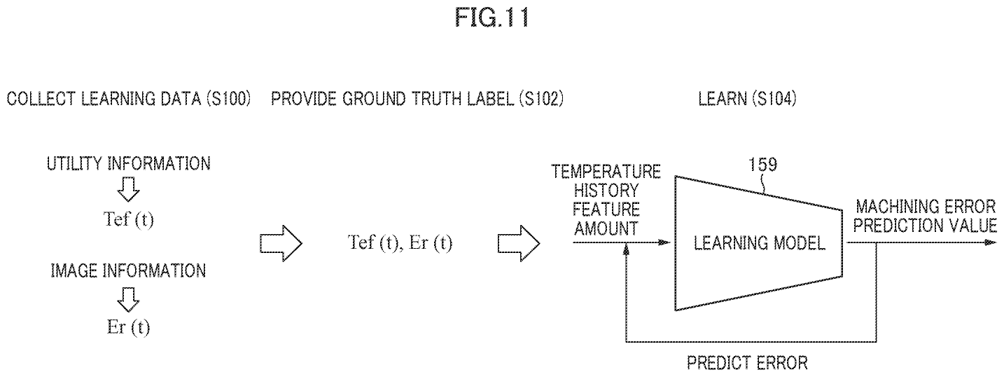

FIG. 11 is a schematic diagram of a learning model generation method. Generation of the trained learning model 158 illustrated in FIG. 5 includes learning data collecting step S100, a ground truth label providing step S102, and a learning step S104.

In the learning data collecting step S100, utility information and image information, which are stored in the control device 26, are collected as learning data. The utility information includes the temperature history of the cutting water, the temperature history of the cooling water and the history of the room temperature, during an operating period of the apparatus. A temperature history feature amount Tef(t) is derived from the temperature history of the cutting water, the temperature history of the cooling water, and the history of the room temperature. The temperature history feature amount Tef(t) represents temperature history feature amounts at different timings.

The temperature history feature amount Tef(t) represents a plurality of temperature history feature amounts at an arbitrary timing t. The temperature history feature amount Tef(t) includes the feature amount of the temperature history of the cutting water at an arbitrary timing t, the feature amount of the temperature history of the cooling water at an arbitrary timing t, and the feature amount of the history of the room temperature at an arbitrary timing t.

The image information is imaging data of the workpiece W acquired when calf check of the apparatus is performed. A machining error Er(t) is derived from the imaging data of the workpiece W. The machining error Er(t) represents machining errors at an arbitrary timing t.

In the ground truth label providing step S102, the machining error Er(t) is provided as the ground truth label to each of the temperature history feature amounts Tef(t), and a pair of the temperature history feature amount Tef(t) and the machining error Er(t) corresponding to the temperature history feature amount Tef(t) is generated as the learning data.

In the learning step S104, supervised learning is performed using the learning data generated in the ground truth label providing step S102. In the supervised learning, the temperature history feature amount Tef(t) is used as input to the learning model 159, and the machining error Er(t) is used as the ground truth data. As a result, the trained learning model 158 illustrated in FIG. 5 is generated.

Re-learning may be performed by applying the procedure of the learning model generation shown in FIG. 11 to the trained learning model 158 illustrated in FIG. 5, using the utility information and the image information stored when the dicing apparatus 10 is operated.

In a case where the machining state is taken into account, in the learning data collecting step S100, the learning data regarding the machining state is collected, and the learning model 158 in which the machining state is taken into account is generated through the ground truth label providing step S102 and the learning step S104.

### [First Modification of Temperature Feature Amount]

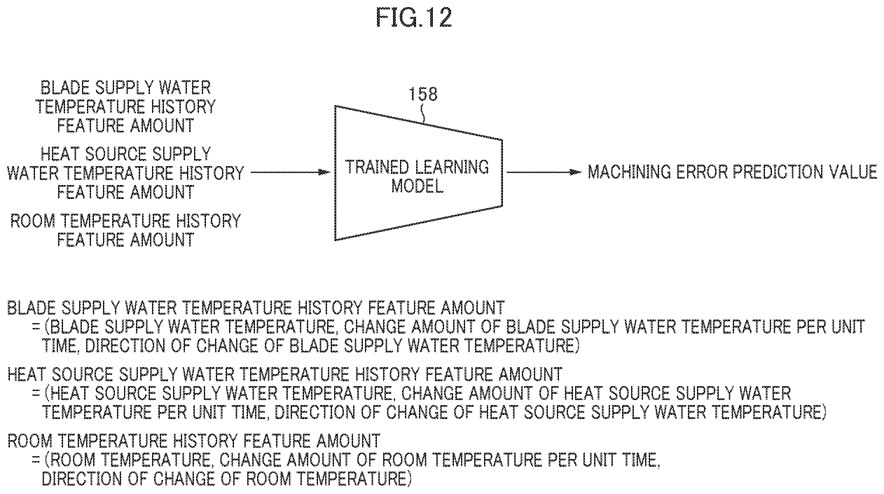

FIG. 12 is an explanatory diagram of a first modification of the temperature history feature amount. According to the first modification, the temperature history feature amount includes a direction of the temperature change, in addition to the temperature and the temperature change amount per unit time. The direction of the temperature change represents increase or decrease of the temperature change amount per unit time and may be calculated as an average change rate of a function representing the temperature change amount per unit time. In other words, assuming that the temperature history is represented as f(t) using a function, the gradient of the temperature change at the i-th timing ti is represented as d²f(ti)/dt² which is a secondary derivative (secondary differential coefficient) of the temperature history f(t).

In other words, as the blade supply water temperature history feature amount according to the first modification, the blade supply water temperature, a change amount of the blade supply water temperature per unit time, and a direction of a change of the blade supply water temperature are applied. As the heat source supply water temperature history feature amount according to the first modification, the heat source supply water temperature, a change amount of the heat source supply water temperature per unit time, and a direction of a change of the heat source supply water temperature are applied. As the room temperature history feature amount according to the first modification, the room temperature, a change amount of the room temperature per unit time, and a direction of a change of the room temperature are applied. The first modification of the temperature history feature amount may be also applied to a modification of the machining state history feature amount.

### [Second Modification of Temperature Feature Amount]

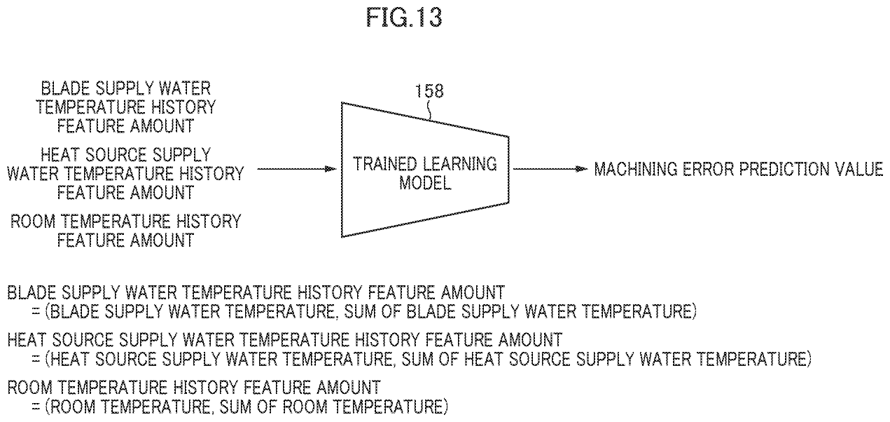

FIG. 13 is an explanatory diagram of a second modification of the temperature history feature amount. As the temperature history feature amount according to the second modification, a sum of the temperature is applied in place of the change amount of the temperature feature amount per unit time. The sum of the temperature is calculated as an interval integral of the temperature history f(t) from a machining start timing to the timing ti assuming that the temperature history is represented as f(t) using a function.

In other words, as the blade supply water temperature history feature amount according to the second modification, the blade supply water temperature and a summation of the blade supply water temperature are applied (“summation” may be abbreviated to “sum”). As the heat source supply temperature history feature amount according to the second modification, the heat source supply water temperature and a summation of the heat source supply water temperature are applied. As the room temperature history feature amount according to the second modification, the room temperature and a summation of the room temperature are applied. The second modification of the temperature history feature amount may be also applied to a modification of the machining state history feature amount.

Note that the summation of the blade supply water temperature described in the second modification is an example of an integrated value of the temperature of the blade supply water. The summation of the heat source supply water temperature described in the second modification is an example of an integrated value of the temperature of the heat source supply water. The summation of the room temperature described in the second modification is an example of an integrated value of the temperature of the machining environment.

### [Third Modification of Temperature Feature Amount]

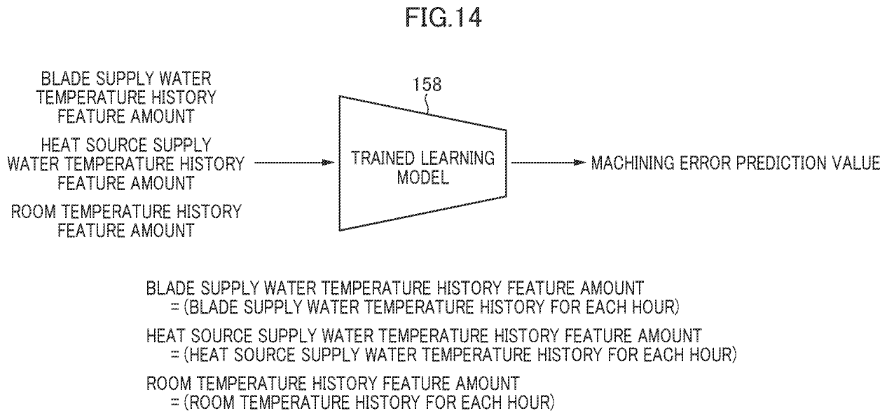

FIG. 14 is an explanatory diagram of a third modification of the temperature history feature amount. In the temperature history feature amount according to the third modification, the temperature history for each hour is applied as the temperature feature amount. In other words, as the blade supply water temperature feature amount according to the third modification, the temperature history of the blade supply water for each hour is applied. As the heat source supply water temperature feature amount according to the third modification, the temperature history of the heat source supply water for each hour is applied. As the room temperature feature amount according to the third modification, the history of the room temperature for each hour is applied.

One hour representing a period of the temperature history may be two hours, three hours, or the like. The period of the temperature history may be specified in accordance with the time constant of the change of the machining error. While the number of samples of the temperature history only requires to be three or more, the machining error may be derived with higher accuracy as the number of samples is larger.

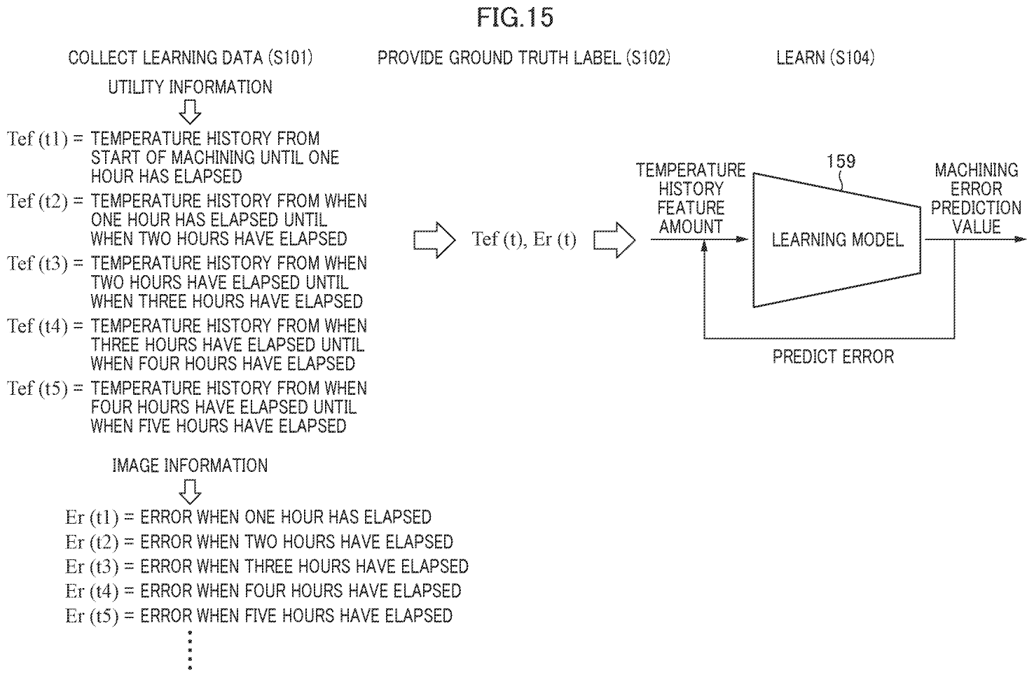

FIG. 15 is a schematic diagram of a method for generating the learning model in which the temperature history feature amount according to the third modification is used as the learning data. In the learning data collecting step S101 shown in FIG. 15, the temperature history for one hour is applied as the temperature history feature amount Tef(t) acquired from the utility information. Further, the machining error Er(t) for each hour is acquired from the image information.

As the ground truth label providing step S102, the machining error Er(t) for each hour is provided to the temperature history feature amount Tef(T) to which the temperature history for one hour is applied. For example, the machining error at a timing at which one hour has elapsed since start of machining is provided to the temperature history feature amount Tef(t) during a period until one hour has elapsed since start of machining.

In the learning step S104, supervised learning is performed using a pair of the temperature history feature amount Tef(t) and the machining error Er(t), as the learning data.

In the supervised learning, the temperature history feature amount Tef(t) is used as input to the learning model 159, and the machining error Er(t) is used as the ground truth data. As a result, the trained learning model 158 illustrated in FIG. 5 is generated.

### [Application Example to Machining State Detection Apparatus and Machining State Detection]

The machining state detecting unit 140 illustrated in FIG. 4 and FIG. 5 may function as the machining state detection apparatus to be applied to the dicing apparatus 10. As the machining state detection apparatus, a computer may be applied. Various kinds of functions of the machining state detection apparatus may be implemented by the computer executing a program.

Further, the history information generating step S10, the history feature amount deriving step S12 and the machining error predicting step S14 shown in FIG. 6 are grasped as a machining state prediction method whose respective steps are performed by a computer which is applied as the machining state detection apparatus.

### [Operational Effects of Embodiment]

The dicing apparatus 10 according to the embodiment can provide the following operational effects.

[1]

The machining error at a timing at which a temperature during machining is acquired is predicted based on a temperature history feature amount at an arbitrary timing during machining. The temperature history feature amount includes a temperature history feature amount of blade supply water, a temperature history feature amount of heat source supply water, and a room temperature history feature amount. This makes it possible to predict a machining error with respect to temperature changes for temperature factors which are difficult to be determined by an operator. Such temperature factors are, for example, temperature factors which have casual relationships to each other and different time constants of the changes.

[2]

The trained learning model 158 is applied to prediction of the machining error. The learning model 158 is trained using a pair of the temperature history feature amount and the machining error as the learning data. The learning model 158 is trained and generated so as to output a prediction value of the machining error, when the temperature history feature amount is input. By this means, improvement in prediction accuracy of the machining error may be expected.

[3]

A temperature at a timing at which the temperature history is acquired and a change amount of the temperature per unit time at the timing at which the temperature history is acquired, are applied as the temperature history feature amount. This makes it possible to implement prediction of the machining error in which the change amount of the temperature per unit time is taken into account.

[4]

A temperature at the timing at which the temperature history is acquired, a change amount of the temperature per unit time at the timing at which the temperature history is acquired and a direction of the temperature change, are applied as the temperature history feature amount. This makes it possible to implement prediction of the machining error in which the direction of the change of the temperature is taken into account.

[5]

The temperature at the timing at which the temperature history is acquired and a summation of the temperature at the timing at which the temperature history is acquired, are applied as the temperature history feature amount. This makes it possible to implement prediction of the machining error in which the summation of the temperature is taken into account.

[6]

The machining error in which the change of the machining state during machining is taken into account is predicted based on the machining state history feature amount at an arbitrary timing during machining. This reduces the machining error caused by the change of the machining state.

[7]

An analyzing unit that predicts transition of the machining error from the prediction value of the machining error is provided. Thus, the machining position may be corrected at an appropriate timing without depending on determination based on an experimental rule of the operator.

[8]

Re-learning of the learning model 158 is performed using utility information and image information stored when the dicing apparatus 10 is operated. This eliminates the necessity of setting and criteria searching corresponding to an environment of the apparatus. The machining position may be appropriately corrected, as the number of times of operation of the dicing apparatus 10 increases.

Components in the embodiment of the present disclosure described above may be changed, added and deleted as appropriate within a range not deviating from the gist of the present disclosure. The present disclosure is not limited to the embodiment described above, and a number of modifications may be made by a person having normal knowledge in the field within technical idea of the present disclosure. Further, the embodiment, the modifications and application examples may be combined as appropriate.

### REFERENCE SIGNS LIST

10 dicing apparatus

12 blade

14 spindle

18 machining unit

26 control device (apparatus control device)

100 system control unit

102 machining control unit

106 blade supply water temperature acquiring unit

108 heat source supply water temperature acquiring unit

110 room temperature acquiring unit

120 computer-readable medium

122 memory

130 blade supply water temperature detecting unit

132 heat source supply water temperature detecting unit

134 room temperature detecting unit

140 machining state detecting unit

150 temperature history generating unit

152 temperature history feature amount deriving unit

154 machining error predicting unit

156 analyzing unit

158 learning model

160 machining condition acquiring unit

162 learning model selecting unit

164 learning model storage unit

Er machining error

Tef temperature history feature amount

What is claimed is:

1. A machining state detection apparatus that detects a machining state when a workpiece is machined with a blade, comprising:
an environmental temperature history acquiring unit that acquires an environmental temperature history representing a temperature history of a machining environment;
a blade supply water temperature history acquiring unit that acquires a blade supply water temperature history representing a temperature history of blade supply water supplied to the blade;
a heat source supply water temperature history acquiring unit that acquires a heat source supply water temperature history representing a temperature history of heat source supply water supplied to a heat source that produces heat when the workpiece is machined;
a temperature history feature amount deriving unit that derives an environmental temperature history feature amount representing features of the environmental temperature history, a blade supply water temperature history feature amount representing features of the blade supply water temperature history, and a heat source supply water temperature history feature amount representing features of the heat source supply water temperature history; and
a machining error predicting unit that predicts a machining error based on a temperature history feature amount including the environmental temperature history feature amount, the blade supply water temperature history feature amount and the heat source supply water temperature history feature amount, wherein
the machining error predicting unit employs a learning model which is trained using the temperature history feature amount and the machining error as learning data, and outputs the machining error in a case where the temperature history feature amount is input.

2. The machining state detection apparatus according to claim 1, further comprising:
a machining state history acquiring unit that acquires a machining state history representing a history of a machining state; and
a machining state history feature amount deriving unit that derives a feature amount of the machining state history, wherein
the machining error predicting unit predicts the machining error while the feature amount of the machining state history is taken into account in the temperature history feature amount.

3. The machining state detection apparatus according to claim 1, wherein
the temperature history feature amount deriving unit acquires a temperature of the machining environment and a change amount of the temperature of the machining environment per unit time, as the environmental temperature history feature amount,
acquires a temperature of the blade supply water and a change amount of the temperature of the blade supply water per unit time, as the blade supply water temperature history feature amount, and
acquires a temperature of the heat source supply water and a change amount of the temperature of the heat source supply water per unit time, as the heat source supply water temperature history feature amount, and
the learning model is generated by performing training using: a combination of the temperature of the machining environment and the change amount of the temperature of the machining environment per unit time; a combination of the temperature of the blade supply water and the change amount of the temperature of the blade supply water per unit time; and a combination of the temperature of the heat source supply water and the change amount of the temperature of the heat source supply water per unit time, as input, to output the machining error.

4. The machining state detection apparatus according to claim 1, wherein
the temperature history feature amount deriving unit acquires a temperature of the machining environment, a change amount of the temperature of the machining environment per unit time, and a direction of a change of the temperature of the machining environment, as the environmental temperature history feature amount,
acquires a temperature of the blade supply water, a change amount of the temperature of the blade supply water per unit time, and a direction of a change of the temperature of the blade supply water, as the blade supply water temperature history feature amount, and
acquires a temperature of the heat source supply water, a change amount of the temperature of the heat source supply water per unit time, and a direction of a change of the temperature of the heat source supply water, as the heat source supply water temperature history feature amount, and
the learning model is generated by performing training using: a combination of the temperature of the machining environment, the change amount of the temperature of the machining environment per unit time, and the direction of the change of the temperature of the machining environment; a combination of the temperature of the blade supply water, the change amount of the temperature of the blade supply water per unit time, and the direction of the change of the temperature of the blade supply water; and a combination of the temperature of the heat source supply water, the change amount of the temperature of the heat source supply water per unit time, and the direction of the change of the temperature of the heat source supply water, as input, to output the machining error.

5. The machining state detection apparatus according to claim 1, wherein
the temperature history feature amount deriving unit acquires a temperature of the machining environment and an integrated value of the temperature of the machining environment, as the environmental temperature history feature amount,
acquires a temperature of the blade supply water and an integrated value of the temperature of the blade supply water, as the blade supply water temperature history feature amount, and
acquires a temperature of the heat source supply water and an integrated value of the temperature of the heat source supply water, as the heat source supply water temperature history feature amount, and
the learning model is generated by performing training using: a combination of the temperature of the machining environment and the integrated value of the temperature of the machining environment; a combination of the temperature of the blade supply water and the integrated value of the temperature of the blade supply water; and a combination of the temperature of the heat source supply water and the integrated value of the temperature of the heat source supply water, as input, to output the machining error.

6. The machining state detection apparatus according to claim 1, further comprising:
a machining condition acquiring unit that acquires machining conditions to be applied to the machining; and
a learning model selecting unit that selects a learning model to be employed in the machining error predicting unit in accordance with the machining conditions, from a plurality of first learning models generated by performing training for the respective machining conditions.

7. A machining state detection method of detecting a machining state when a workpiece is machined using a blade, the machining state detection method comprising:
an environmental temperature history acquiring step of acquiring, by a control device, an environmental temperature history representing a temperature history of a machining environment;
a blade supply water temperature history acquiring step of acquiring, by the control device, a blade supply water temperature history representing a temperature history of blade supply water supplied to the blade;
a heat source supply water temperature history acquiring step of acquiring, by the control device, a heat source supply water temperature history representing a temperature history of heat source supply water supplied to a heat source that produces heat when the workpiece is machined;
a temperature history feature amount deriving step of deriving, by the control device, an environmental temperature history feature amount representing features of the environmental temperature history, a blade supply water temperature history feature amount representing features of the blade supply water temperature history, and a heat source supply water temperature history feature amount representing features of the heat source supply water temperature history; and
a machining error predicting step of predicting, by the control device, a machining error based on a temperature history feature amount including the environmental temperature history feature amount, the blade supply water temperature history feature amount and the heat source supply water temperature history feature amount, wherein
the machining error predicting step employs a learning model which is trained using the temperature history feature amount and the machining error as learning data, and outputs the machining error in a case where the temperature history feature amount is input.

8. A non-transitory, computer-readable tangible recording medium which records thereon a program for causing a control device including a computer to detect a machining state when a workpiece is machined with a blade, the program causes the control device to implement functions comprising:
an environmental temperature history acquiring function of acquiring an environmental temperature history representing a temperature history of a machining environment;
a blade supply water temperature history acquiring function of acquiring a blade supply water temperature history representing a temperature history of blade supply water supplied to the blade;
a heat source supply water temperature history acquiring function of acquiring a heat source supply water temperature history representing a temperature history of heat source supply water supplied to a heat source that produces heat when the workpiece is machined;
a temperature history feature amount deriving function of deriving an environmental temperature history feature amount representing features of the environmental temperature history, a blade supply water temperature history feature amount representing features of the blade supply water temperature history, and a heat source supply water temperature history feature amount representing features of the heat source supply water temperature history; and
a machining error predicting function of predicting a machining error based on a temperature history feature amount including the environmental temperature history feature amount, the blade supply water temperature history feature amount and the heat source supply water temperature history feature amount, wherein
the machining error predicting function employs a learning model which is trained using the temperature history feature amount and the machining error as learning data, and outputs the machining error in a case where the temperature history feature amount is input.

9. A dicing apparatus comprising:
a machining unit that machines a workpiece with a blade; and
a machining state detecting unit that detects a machining state of the workpiece, wherein
the machining state detecting unit comprises:
an environmental temperature history acquiring unit that acquires an environmental temperature history representing a temperature history of a machining environment;
a blade supply water temperature history acquiring unit that acquires a blade supply water temperature history representing a temperature history of blade supply water supplied to the blade;
a heat source supply water temperature history acquiring unit that acquires a heat source supply water temperature history representing a temperature history of heat source supply water supplied to a heat source that produces heat when the workpiece is machined;
a temperature history feature amount deriving unit that derives an environmental temperature history feature amount representing features of the environmental temperature history, a blade supply water temperature history feature amount representing features of the blade supply water temperature history, and a heat source supply water temperature history feature amount representing features of the heat source supply water temperature history; and
a machining error predicting unit that predicts a machining error based on a temperature history feature amount including the environmental temperature history feature amount, the blade supply water temperature history feature amount, and the heat source supply water temperature history feature amount, wherein
the machining error predicting unit employs a learning model which is trained using the temperature history feature amount and the machining error as learning data, and outputs the machining error in a case where the temperature history feature amount is input.

10. The dicing apparatus according to claim 9, further comprising:
a determining unit that determines whether or not it is necessary to correct the machining unit based on the machining error output from the machining error predicting unit.

11. The dicing apparatus according to claim 10, wherein
the machining error predicting unit predicts a machining error after a specified period has elapsed, and
the determining unit derives a determination result indicating that it is necessary to correct the machining unit in a case where the predicted machining error exceeds a specified threshold.

12. The dicing apparatus according to claim 11, wherein
the machining error predicting unit predicts a machining error after a specified period has elapsed based on a change amount of the machining error per unit time and a direction of a change of the machining error.

13. A learning model generation method of generating a learning model which outputs a machining error when a workpiece is machined with a blade in a case where the temperature history feature amount is input, comprising
training, using learning data including a temperature history feature amount including an environmental temperature history representing a temperature history of a machining environment, a blade supply water temperature history representing a temperature history of blade supply water supplied to the blade, and a heat source supply water temperature history representing a temperature history of heat source supply water supplied to a heat source that produces heat when the workpiece is machined, and a machining error when the workpiece is machined.
